(19) United States
(12) Patent Application Publication
(10) Pub. No.: US 2024/0262205 A1
(43) Pub. Date: Aug. 8, 2024

(54) METHOD FOR PROVIDING MEDIA CONTENT WHICH IS ADAPTED TO THE MOVEMENT OF A VEHICLE, AND VEHICLE

(71) Applicant: MERCEDES-BENZ GROUP AG, Stuttgart (DE)

(72) Inventors: Alexander HANUSCHKIN, Karlsruhe (DE); Teresa BOTSCHEN, Althengstett (DE)

(21) Appl. No.: 18/292,391

(22) PCT Filed: Jul. 15, 2022
(86) PCT No.: PCT/EP2022/069846

§ 371 Date: Jan. 26, 2024

(30) Foreign Application Priority Data
Jul. 27, 2021 (DE) 10 2021 003 887.8

(51) Int. Cl. B60K 35/85; B60K 35/28

(52) U.S. Cl. CPC B60K 35/85; B60K 35/28; B60K 2360/166; B60K 2360/169; B60K 2360/176; B60K 2360/1876; B60K 2360/5915

(57) ABSTRACT

A method for providing media content adapted to the movement of a vehicle involves detecting current driving dynamic information of a first vehicle, estimating future driving dynamic information of at least the first vehicle, and transmitting the current and future driving dynamic information and camera images recorded by a vehicle camera to a central computing unit. The current and/or future driving dynamic information and the camera images are provided for outputting purposes in a third-party device or driving dynamic information of at least one second vehicle corresponding at least to the current and/or the future driving dynamic information of the first vehicle is identified. The current and/or future driving dynamic information and the camera images of at least the second vehicle to the first vehicle and at least the camera images of the second vehicle are output on at least one display device of the first vehicle.

### BACKGROUND AND SUMMARY OF THE INVENTION

Exemplary embodiments of the invention relate to a method for providing media content adapted to the movement of a vehicle and to a vehicle for carrying out the method.

In certain scenarios, a person who is driving a vehicle may become bored during the journey. This is particularly the case during monotonous sections of a journey. Such monotonous sections of a journey occur, for example, in traffic jams and/or when travelling in a vehicle that is controllable in an at least partially automated, in particular highly automated manner.

To prevent boredom, vehicle occupants can consume entertainment media with the aid of an infotainment system, such as listen to music, watch films, listen to the radio, play video games or the like. Vehicle occupants can also distract themselves with the aid of books or mobile devices such as a smartphone or tablet.

Methods for transmitting telemetry data from a moving system to a static system are also known. Hence, for example, in Formula 1, sensor data describing a vehicle status and a live feed from an onboard camera are transmitted from the racing car to the driver's cab of a racing team for monitoring and system analysis, and to a TV station for presentation of the telemetry data to viewers.

A method for supporting a user of a vehicle based on traffic behavior models is known from U.S. Pat. No. 10,147,324 B1. The document describes a vehicle determining traffic behavior of other road users and adjusting its own traffic behavior, in other words maneuvering behavior, depending on the traffic behavior of the other road users. For this purpose, control information for manual control can be output to a person driving the vehicle and/or control commands can be generated for the at least partially automated control of the vehicle. To estimate the expected behavior of the other road users, behavior that is typically expected of corresponding road users in the corresponding traffic situation is read from a database. To analyze the traffic situation, among other things, camera images are evaluated here. Taking into consideration applicable traffic regulations such as speed limits, an existing road layout, recognized lanes or the like, an expected maneuvering behavior of the road user is then estimated. Sensor values collected by vehicles here are exchanged directly by means of vehicle-to-vehicle communication interface between the vehicles and/or sent wirelessly to a central computing unit.

Exemplary embodiments of the present invention are directed to a method for providing media content which is adapted to the movement of a vehicle to improve comfort for occupants of a vehicle during the journey.

In a method for providing media content adapted to the movement of a vehicle at least the following method steps are carried out according to the invention:
detecting current driving dynamic information of at least one first vehicle;
estimating future driving dynamic information of at least the first vehicle;
transmitting the current and future driving dynamic information and camera images recorded by a vehicle camera to a central computing unit;
providing the current and/or future driving dynamic information and the camera images from the central computing unit for outputting purposes by a third-party device; and/or
identifying current and/or future driving dynamic information of at least one second vehicle which corresponds to at least the current and/or the future driving dynamic information of the first vehicle within a tolerance limit by the central computing unit;
transmitting the current and/or future driving dynamic information and the camera images of at least the second vehicle to the first vehicle; and
outputting at least the camera images of the second vehicle on at least one display device of the first vehicle.

With the aid of the method according to the invention, vehicle occupants, such as a person driving the vehicle, a front-seat passenger, or a passenger in the back, are able to experience a journey being carried out simultaneously by another vehicle. This entertains the vehicle occupants since they are therefore given a “broader view” while using their own vehicle. For example, the first vehicle is travelling in a metropolitan area in Germany. The second vehicle is also travelling in a metropolitan area in India. This enables the vehicle occupants at least to go on an imaginary journey during a monotonous traffic situation.

The camera images output in the first vehicle come from a second vehicle having driving dynamics corresponding to the first vehicle. Since the acceleration forces occurring in the first vehicle therefore correspond to the acceleration forces acting in the second vehicle within a tolerance limit, the camera images output in the first vehicle can be viewed without the occurrence of kinetosis. If a vehicle occupant is unable here to perceive their own surroundings around the first vehicle, for example because it is nighttime or a view out of a vehicle window is blocked, the occurrence of kinetosis can be countered by looking at the camera images.

Driving dynamic information includes, for example, vehicle speed, acceleration, or steering angle. Therefore, if the first vehicle is travelling around a left-hand bend, for example, at a certain speed such as 30 km/h, then only those camera images in which the second vehicle is also travelling around a left-hand bend at 30 km/h are shown in the first vehicle. The second vehicle is selected so that the driving dynamic information matches within a defined tolerance limit. This means that the second vehicle can also travel around a left-hand bend, for example, at a slightly different steering angle, for example a steering angle differing by +1° or −2°, and a slightly different speed, such as 28 km/h or 35 km/h, in order to be classified as suitable for display in the first vehicle.

Similarly, at least also the camera images taken by the first vehicle and if applicable also additionally the driving dynamic information can be output in the second vehicle.

It takes the central computing unit a certain amount of time to find at least two vehicles with the driving dynamic information that matches within the defined tolerance limit. By estimating future driving dynamic information, the amount of time required by the central computing unit to assign, that is to say match, the vehicles to one another can be bridged. This ensures that the driving dynamics of the two vehicles that are matched to one another also actually match in terms of time. A match here also means that there may be a time offset between the driving dynamics of the two vehicles. Hence, for example, travelling around a bend and therefore the occurrence of lateral acceleration forces in one of the vehicles may occur, for example, 500 ms earlier than in the other vehicle. The time difference between the vehicles is so small here that the driving dynamics of the vehicles feel the same to the respective occupants of the vehicles.

Furthermore, the method according to the invention offers the possibility for social interaction between the vehicle occupants. If this is desired by the vehicle occupants, then a function can also be provided that enables contact to be made with the vehicle occupants of the second vehicle. Hence, for example, the vehicle occupants of the first vehicle can chat to the vehicle occupants of the second vehicle or speak to them on the telephone. As a result, the vehicle occupants of the first vehicle and also of the second vehicle can distract themselves to an even greater extent from a monotonous travelling situation. The contact function is preferably provided only for pairs of vehicles in which matching procedures have already been carried out a defined minimum number of times and/or for a defined minimum period in the past. This increases the likelihood that the vehicle occupants of the respective vehicles will be interested in one another since they already “know” each other.

The camera images transmitted from the second vehicle into the first vehicle, which may generally be photos or video recordings, can be displayed on any desired display device. For this purpose, use can be made, for example, of a head unit, an instrument cluster, a head-up display (HUD) or a virtual reality or augmented reality projection surface integrated into a window of the vehicle. A vehicle occupant can also use, for example, virtual reality or augmented reality glasses to display the camera images.

It is also possible for the current and/or future driving dynamic information obtained from the first vehicle, and also the camera images to be forwarded from the central computing unit to a third-party device. This third-party device may, for example, be a simulator. Such a simulator may, for example, be positioned in an amusement park or be operated by a vehicle manufacturer to develop vehicles. For example, the simulator may comprise a screen onto which the camera images of the first vehicle are projected. The simulator may also have actuators, in particular six actuators, also referred to as a “hexapod”, through which the simulator is moved according to the driving dynamic information of the first vehicle. This enables the users of the simulator to experience the driving dynamics of the first vehicle.

Since the future driving dynamic information of the first vehicle is used in order to drive the actuators of the simulator and the future driving dynamic information is further processed in order to derive control signals of the actuators, there is no time delay between the driving dynamics perceived in the first vehicle and the driving dynamics experienced in the simulator. This enables limitations of actuator functions to be offset. Hence, for example, a limited maximum actuator lift and/or a maximum actuator acceleration can be taken into consideration for driving the actuators of the simulator.

Any desired vehicle camera may be used to generate the camera images. The vehicle camera is preferably aligned in the direction of travel of the vehicle. A plurality of vehicle cameras, in particular pointing in different directions, may also record camera images and these are exchanged between the vehicles. Most preferably, the two vehicle cameras whose camera images are exchanged between the vehicles are pointing in the same direction in relation to a longitudinal axis of the vehicle. This improves the feeling of immersion for the vehicle occupants when viewing the respective camera images transmitted from the other vehicle.

In addition to the camera images, the driving dynamic information or only some of the driving dynamic information can be displayed in the further vehicle or the third-party device. For example, the current or the estimated travelling speed of the vehicle can be output.

Any desired wireless communication technologies such as mobile radio, Wi-Fi, Bluetooth, or the like may be used for the data transmission of the driving dynamic information and the camera images from a vehicle to the central computing unit.

An advantageous refinement of the method provides, in addition to the camera images and the current and/or future driving dynamic information, for additional information to be transmitted to at least one third-party device and/or at least one second vehicle for outputting purposes. If at least three or more vehicles with similar driving dynamic information, that is to say lying within the tolerance limit, are found by the central computing unit, then the camera images and, if required, the current and/or future driving dynamic information, referred to hereinbelow as the media content, are also shared between a plurality of vehicles. In addition, additional information can also be transmitted to the respective vehicles and the respective third-party devices. It is possible here for at least the additional information also to be exchanged directly, that is to say without intermediary, between the vehicles by means of a vehicle-to-vehicle communication interface. However, the additional information can also be exchanged between the vehicles indirectly, that is to say via the central computing unit.

According to a further advantageous configuration of the method, at least one of the following variables is used as additional information:
status information describing a status of the first vehicle;
surroundings information describing a status of the surroundings of the first vehicle; and/or
an audio track, preferably an audio track in the form of external microphone recordings.

With the aid of the additional information, the vehicle occupants of the first and second vehicles, and the users of the third-party device are able to receive detailed information from the corresponding vehicles involved in providing the media content. Accordingly, additional information can also be transmitted from the second vehicle into the first vehicle.

The status information may be a geo-position of the vehicle, a current content of the tank of the vehicle, route information of a route being travelled by the vehicle from a starting point to a destination, an oil temperature of the vehicle, or the like.

The surroundings information may be a current location time, a temperature of the surroundings, current weather conditions, that is to say current weather such as sun, rain, snow or the like, information on current traffic volumes, or the like.

With the aid of the audio track, in particular in the form of external microphone recordings, the vehicle occupants of the first vehicle can, in addition, also perceive the acoustics in the nearby surroundings around the second vehicle and the vehicle occupants of the second vehicle can perceive the acoustics around the first vehicle. This enables an even more immersive experience when using the method according to the invention. If the first vehicle, for example, is in a traffic jam in a town and the second vehicle is travelling through a bazaar in New Delhi, then vehicle occupants of the first vehicle can perceive the sounds of the bazaar in New Delhi. It is also possible, for example, for sounds from an engine space or near an exhaust pipe to be recorded in order, for example, to transmit the engine noises of one vehicle to the other. Audio recordings can also be made in the vehicle interior. For example, the vehicle occupants of the different vehicles can speak to one another on the telephone.

A further advantageous configuration of the method further provides for a current and/or future road layout of a road being travelled along by the first vehicle, a current and/or future traffic situation and/or a travel trajectory plan to be taken into consideration to determine the future driving dynamic information. It is to be expected that the first vehicle will follow the current or the future road layout. It is therefore possible to estimate the future driving dynamic information from the road layout. A traffic situation may show that there is a traffic jam or slow-moving traffic or that a vehicle is able to travel freely on an open road. Hence, taking the traffic situation into consideration, it is possible to estimate the future driving dynamics even more reliably. If, for example, the first vehicle is travelling along a straight road, the driving dynamic information might therefore comprise a constant speed, no steering angle, and no acceleration. However, if the vehicle is approaching a traffic jam or moving in slow-moving traffic, then, for example, steering angle changes to change lanes or longitudinal and/or transverse accelerations occur. In a vehicle that is controllable in an at least partially automated manner, it is also possible, in addition, to take a travel trajectory plan into consideration for determination of the future driving dynamic information. With the aid of a travel trajectory plan, it is possible to estimate future driving dynamic information even more reliably since the driving maneuvers soon carried out by the vehicle are specified by a control device and are therefore known.

According to a further advantageous configuration of the method according to the invention, a road layout and/or a traffic situation are determined by:
an image analysis of at least one camera image generated by the vehicle camera;
extraction of a variable derived from an assistance system; and/or
analysis of digital maps, in particular during active navigation.

With the aid of image analysis, it is also possible to recognize the current and if applicable also the future road layout from camera images generated by the camera. Similarly, a current traffic situation can also be recognized by image analysis. If, for example, there are a particularly large number of vehicles in a specific camera image, then it can be assumed that there is a traffic jam or slow-moving traffic. It is also possible for a change of road user density in successive camera images to be evaluated in order to estimate a future traffic situation. If, for example, a number of vehicles increases in successive camera images as time passes, then it can be concluded that a traffic jam is imminent. Similarly, it can be concluded through recognition of a stop sign or a red light that a braking maneuver will soon be required. Traffic signs, sets of lights, a road layout, or the like can also be established through analysis of digital maps. If navigation is actively being carried out here, then it is also known, for example, in which direction a vehicle will turn at a crossroads or T-junction. As a result, the future driving dynamic information can be estimated even more reliably.

The road layout and/or the traffic situation can also be determined by extracting a variable derived from an assistance system. Such a variable may be a wheel speed, acceleration forces, distance information calculated with the aid of a radar system or LiDAR system, or the like. In particular, future driving dynamic information can be estimated even more reliably through sensor fusion or measured value fusion.

A further advantageous configuration of the method further provides for a person driving the first vehicle to be identified and for a clear profile to be assigned thereto. Driving dynamic information can be estimated even more reliably with the aid of a clear user profile. Hence, future driving dynamic information, that is to say, for example, a lateral acceleration when travelling around a bend, alongside the pure road layout and the traffic situation, also depends on the driving style of a person driving the vehicle. A first person travels around a bend, for example, comparatively slowly and a second person travels around the same bend, for example, at a higher speed since the second person tends towards a sporty driving style. By taking into consideration the person who is driving the vehicle, it is therefore possible to estimate the future driving dynamic information even more reliably.

Different generally known methods and processes can be used to identify people. Hence, for example, a person can be recognized by reference to biometric features such as through an iris scan, voice analysis, facial recognition, a fingerprint scan, or the like. It is also conceivable for different people to have their own user profile, a corresponding person logging in to the vehicle through a combination of user name and personal password. For this purpose, corresponding login data can be input via the infotainment system of the vehicle or a mobile device that is in communication connection with the vehicle. A person can also be clearly recognized with the aid of an individual vehicle key. A clear identification of the person is stored on the vehicle key here, for example in the form of a digital hash value. The vehicle key may consist here of a physical key, in particular a radio key, or of software run on a mobile device. For example, communication between vehicle key and vehicle may be carried out via ultrabroadband communication here.

According to a further advantageous configuration of the method according to the invention, machine learning methods are used to estimate the future driving dynamic information. The future driving dynamic information can be estimated even more reliably with the aid of machine learning methods. Hence, for example, an artificial neural network can be used to evaluate camera images. In particular, the driving behavior of a user filed in a user profile is trained with the aid of artificial intelligence. The longer a particular person therefore uses a particular vehicle, the better the vehicle learns the driving behavior of the corresponding person. As a result, the vehicle can also estimate the future driving dynamic information specific to that person even more reliably. A corresponding artificial neural network can be trained, for example, during the manufacture of the vehicle and individualized for different people during use of the vehicle through evaluation of a corresponding driving behavior.

A further advantageous configuration of the method further provides for the central computing unit to compare with one another the roads travelled along by different vehicles and to assign to one another roads with a similar road layout above a minimum road length within a defined tolerance threshold. At least two vehicles that are travelling along such “similar roads” can be matched to one another even more quickly through the similar roads assigned to one another and the corresponding camera feeds are displayed in the respective other vehicle. As a result, any need for calculation or time taken to match different vehicles to one another is reduced. This enables driving dynamic information and/or camera feeds to be displayed in different vehicles even if the future driving dynamic information could only be roughly estimated. Different roads around the world can be compared with one another here.

The more vehicles travel along a particular road or a particular section of road, the more reliably present driving dynamic information can also be determined here with the aid of statistical methods while a particular section of road or a particular road is being travelled along. So that a plurality of roads or sections of road are classified as similar within the defined tolerance threshold, they have to have the same layout over the minimum road length, for example 10 meters, 100 meters or a number of kilometers, that is to say extend straight ahead and/or have any desired number of bends. The bends may have the same bend radius or have a slightly different bend radius here. If a first and a second vehicle are travelling along similar roads, then the respective current and/or future driving dynamic information and the camera images of the individual vehicles can be exchanged between one another. If the corresponding vehicles depart from the similar section of road, then the vehicle from which, for example, the first vehicle receives corresponding media content also changes. In other words, the reproduction of driving dynamic information and camera images of the second vehicle is brought to an end in the first vehicle when it leaves a similar section of road and the reproduction of driving dynamic information and camera images of a third vehicle which is travelling along a section of road that is now similar to that of the first vehicle is started.

According to a further advantageous configuration of the method according to the invention, user preferences are taken into consideration for selecting and/or displaying media content. The media content is at least the camera images and, if required, the current and/or future driving dynamic information. In addition, the additional information may also be displayed. Taking user preferences into consideration, a user of the method according to the invention may, for example, state that they only want to receive camera images from vehicles travelling either in a similar geographical region to their own vehicle, for example in the same country, the same Federal state, or in the same district. Similarly, the user may also stipulate that they only want to receive camera images from vehicles travelling, for example, in a different country. For example, the user may also stipulate that they only want to receive camera images from vehicles showing driving only during the day or only at night. Accordingly, the user may also stipulate that the weather conditions around the second vehicle should be the same as or different to the weather conditions around the first vehicle. If the first vehicle, for example, is travelling through a snowy landscape in winter, then the user can stipulate that camera images only be taken into consideration from second vehicles which are likewise travelling through a wintry landscape or which, for example, are travelling along a seafront in the sun.

The user may also stipulate preferences for the displaying of media content. Hence, for example, the user may state that the camera images of a second vehicle that are displayed in the first vehicle be adapted. Hence, for example, a corresponding camera feed from the second vehicle can be made brighter or its color reproduction can be altered. A camera feed recorded at night, for example, can be made brighter so that dark camera images can be seen more clearly during the day. Artificial intelligence methods, such as machine learning, can also be used to do this.

Preferably, at least information on the manual control of the first vehicle by the person driving the vehicle and/or at least a control command for the at least partially automated control of the first vehicle is derived from the driving dynamic information transmitted from a second vehicle to the first vehicle. If, for example, the second vehicle is able to estimate future driving dynamic information particularly reliably, that is to say accurately, and the first vehicle is able to estimate the future driving dynamic information only roughly, then the driving dynamic information of the second vehicle is transmitted into the first vehicle and used there for the purposes of outputting control information and/or control commands. As a result, the first vehicle can be controlled in a more reliable and therefore safer manner. Road safety in traffic is thereby improved.

In a vehicle with at least one vehicle camera, a computing unit, a wireless communication interface, and at least one display device, according to the invention, the vehicle camera, computing unit, wireless communication interface and display device are arranged to carry out a method described above. The vehicle may be any desired vehicle, such as a passenger vehicle, lorry, transporter, bus, rickshaw, or the like. Camera feeds exchanged between a plurality of vehicles are recorded by cameras pointing in the same direction in relation to a longitudinal axis of the vehicle. This ensures that vehicle occupants are placed particularly immersively into a travelling situation of another vehicle. Since the driving dynamic information between the two vehicles corresponds and the display of the camera images corresponds to the corresponding driving dynamic information, kinetosis can also be prevented with the aid of a method according to the invention. For example, the vehicle may have screens in a back of a driver's or front passenger's seat. Hence, driving from other vehicles can be played on the corresponding screens, as a result of which passengers sitting in the back can follow this driving. If, for example, the vehicle now changes lane, turns off or accelerates or brakes, then the vehicle whose camera images are being displayed on the displays does this too. Since the movements of the two vehicles correspond, kinetosis of the passengers in the back is prevented.

With the aid of the computing unit, sensor values detected by vehicle sensors, and the camera images of the vehicle camera, are detected and if applicable pre-processed before transmission to the central computing unit via the wireless communication interface. For this purpose, a plurality of computing units can also be used. Such a computing unit is, for example, a central onboard computer, a control device of a vehicle subsystem, a telemetry or telematics unit, or the like. The media content can be displayed on different displays such as a head unit, an instrument cluster, any desired vehicle display or the like. In general, it is also conceivable for a mobile device like a smartphone, tablet, laptop, or the like to be connected to the vehicle and the corresponding media content to be reproduced on the mobile device.

According to a particularly advantageous embodiment of the vehicle according to the invention, this is controllable in an at least partially automated manner. In a vehicle that is controllable in an at least partially automated, preferably highly automated manner, traffic situations may arise in which the person driving the vehicle does not have to actively control the vehicle themselves. In particular, in such a situation, the person driving the vehicle may quickly become bored. However, with the aid of the method according to the invention, the person driving the vehicle can distract themselves. This improves the comfort of the person driving the vehicle and also of further vehicle occupants.

### BRIEF DESCRIPTION OF THE DRAWING FIGURES

Further advantageous configurations of the method according to the invention for providing media content and of the vehicle according to the invention are also evident from the exemplary embodiments which are described in more detail below with reference to the figures, in which:

FIG. 1 shows a schematic diagram of an exchange between vehicles of media content adapted to a movement of a vehicle;

FIG. 2 shows a schematic diagram of an assignment to one another of two vehicles with similar driving dynamics;

FIG. 3 shows a schematic diagram of an outputting of media content generated by a first vehicle on a display device of a second vehicle; and

FIG. 4 shows a flow diagram of a method according to the invention.

### DETAILED DESCRIPTION

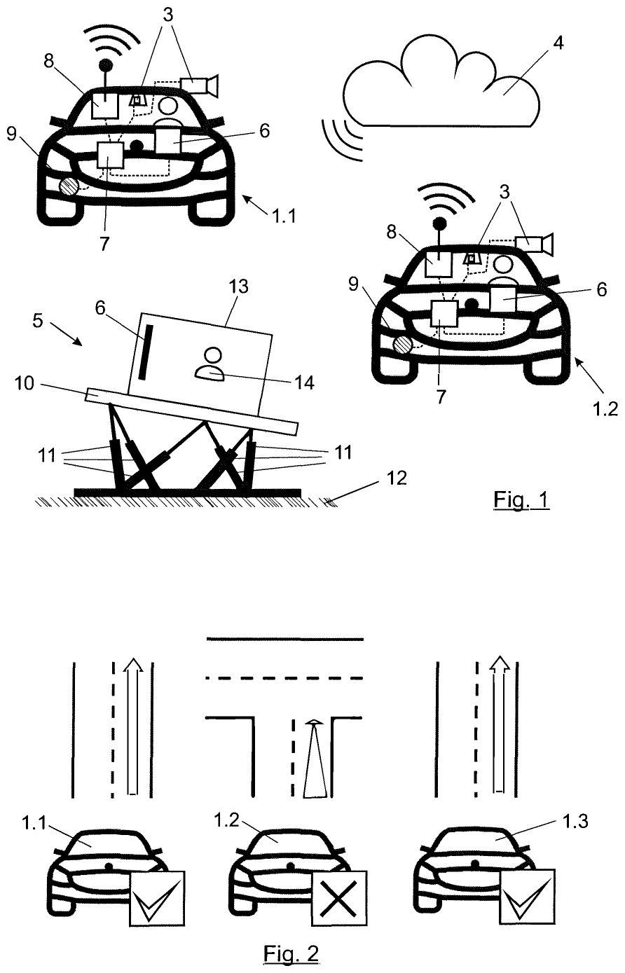

FIG. 1 shows a first vehicle 1.1 according to the invention and a second vehicle 1.2 according to the invention. The respective vehicles 1.1 and 1.2 each comprise at least one vehicle camera 3, a computing unit 7, at least one display device 6, and a wireless communication interface 8. The vehicles 1.1 and/or 1.2 may also have at least one sensor 9 for detecting status information, surroundings information, and/or audio recordings. The sensor 9 may, for example, be in the form of a microphone, a temperature sensor, a speed sensor, a brightness sensor, or the like.

A respective vehicle 1.1, 1.2 may also have a plurality of vehicle cameras 3. The respective vehicle cameras 3 may be pointing in different directions. For example, a first vehicle camera 3 may be aligned parallel to a longitudinal axis of the vehicle and detect a field of vision lying in a forward direction ahead of a vehicle 1.1, 1.2. At least one further vehicle camera 3 may be arranged on the vehicle 1.1, 1.2 parallel to a vehicle transverse axis or offset at any desired angle to the longitudinal and transverse axes of the vehicle. As a result, for example, side areas and/or rear areas behind a vehicle 1.1, 1.2 may also be detected. In particular, a vehicle camera 3 may detect not only visible light, but also infrared light. This enables surroundings to be detected even in adverse visibility conditions such as in the dark.

The at least one vehicle camera 3 generates camera images, which are transmitted to the computing unit 7 for processing. Through evaluation of the camera images, for example, a current and/or future road layout of a road being travelled along by the respective vehicle 1.1, 1.2 and/or a current and/or future traffic situation can be determined. Through analysis of the road layout and/or of the traffic situation, future driving dynamic information, that is to say an expected vehicle speed, vehicle acceleration and/or a steering angle of the vehicle 1.1, 1.2, can then be estimated.

The respective vehicle 1.1, 1.2 also detects current driving dynamic information. This can likewise be determined through evaluation of the camera images and/or through evaluation of sensor data generated by at least one sensor 9. For example, at least one sensor 9 may be configured as an acceleration sensor. The current and future driving dynamic information is sent together with the camera images generated by the at least one vehicle camera 3 via the wireless communication interface 8 to a central computing unit 4, for example a cloud server, also referred to as a back end. For this purpose, any desired radio technology, such as mobile radio, Wi-Fi, Bluetooth, NFC, or the like, can be used as the wireless communication technology. The wireless communication interface 8 may, in particular, be configured as a vehicle-to-vehicle communication interface and/or vehicle-to-infrastructure interface.

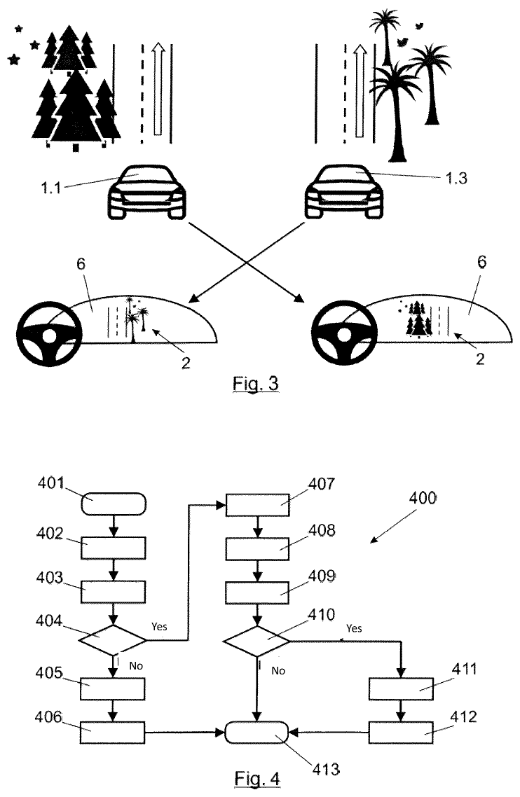

The central computing unit 4 identifies at least one second vehicle 1.2 whose current and/or future driving dynamic information corresponds to the current and/or future driving dynamic information of the first vehicle 1.1 within a defined tolerance limit. If such a vehicle is found, then the media content 2 recorded by the first vehicle 1.1, which is shown in more detail in FIG. 3, is transmitted to the second vehicle 1.2 and vice versa. The media content 2 is the camera images and, if required, the current and/or future driving dynamic information. Accordingly, media content 2 recorded by the second vehicle 1.2 is transmitted via the central computing unit 4 to the first vehicle 1.1. The corresponding media content 2 is then output on the display device 6 of the respective vehicle 1.1, 1.2.

It is also possible for the media content 2 recorded by the first vehicle 1.1 to be transmitted by the central computing unit 4 to a third-party device 5, for example a simulator, for outputting purposes. FIG. 1 shows such a third-party device 5. The third-party device 5, here in the form of the simulator, comprises a movement platform 10 which is movable with respect to a stationary floor 12 via actuators 11, in particular six actuators 11. Placed onto the movement platform 10 is a cockpit 13 with at least one display device 6, for example a screen for presenting the media content 2 of a passenger 14. Depending on the size of the simulator, the cockpit 13 may have any desired number of seats so that the respective passengers 14 can experience the media content 2 comfortably and safely. The actuators 11 are moved according to a control signal derived through evaluation of the current and/or future driving dynamic information. Hence, acceleration forces occurring with a vehicle 1.1, 1.2 during a journey can also be relived in the simulator. Using the future driving dynamic information enables the simulator to be used to its full capacity. Hence, for example, in deriving the control commands, a maximum actuator lift and/or a maximum actuator operation speed can be taken into consideration in order to enable reliable reproduction of the future driving dynamic information.

Hence, for example, it is possible to prevent the movement platform 10 being able to be tipped any further by reaching a stop, meaning that, for example, a greater acceleration force can be simulated.

FIG. 2 shows how the central computing unit 4 determines a plurality of vehicles 1.1, 1.3 with identical driving dynamics, that is to say driving dynamics corresponding within the tolerance limit. For this purpose, the current and future driving dynamic information transmitted by the vehicles 1.1, 1.2 and 1.3 to the central computing unit 4 is compared and vehicles 1.1, 1.3 with corresponding driving dynamic information are assigned. In the example in FIG. 2, the first vehicle 1.1 and the third vehicle 1.3 are travelling straight ahead at similar speeds, for example 130 km/h and 135 km/h respectively, on a straight section of road. The speed of the vehicles 1.1 and 1.3 is constant here. The second vehicle 1.2, on the other hand, is travelling towards a T-junction with negative acceleration and then turning left or right. Since the second vehicle 1.2 is moving along at a lower speed, for example 50 km/h, and a negative acceleration is also affecting the second vehicle 1.2 owing to a braking process, the driving dynamic information of the second vehicle 1.2 cannot be correlated to that of the first and third vehicles 1.1, 1.3.

FIG. 3 shows the reproduction of media content 2 on the respective display devices 6 of the first and third vehicles 1.1, 1.3. Hence, the first vehicle 1.1 is travelling through a piece of woodland in the twilight. For example, the first vehicle 1.1 could be in Alaska, the Black Forest, Siberia, or a similar region. The third vehicle 1.3, on the other hand, is travelling along a seafront in the sunshine, for example on Miami Beach, the Cote d′Azur, or the Italian Riviera. The camera images recorded by the respective vehicles 1.1 and 1.3 by means of the vehicle camera 3 are then transmitted to the other respective vehicle 1.3, 1.1 by means of the wireless communication interface 8 and the central computing unit 4 and output on the display devices 6 of the vehicles 1.3, 1.1. This enables the vehicle occupants of the corresponding vehicles 1.1, 1.3 to perceive the media content 2 recorded by the other vehicle 1.3, 1.1. This increases the comfort of the respective vehicle occupants. Hence, the vehicle occupants can distract themselves in a monotonous and boring travelling situation. This is particularly important for autonomously controllable vehicles since here a person driving the vehicle can also devote their activity to things other than the driving.

In addition to perceiving the media content 2 recorded by the other vehicle 1.3, 1.1, communication between the occupants of vehicles 1.1, 1.3 connected with one another through the exchange of media content 2 can also be enabled. This can take place, for example, by offering telephone or chat connections to the occupants. This increases the attractiveness and authenticity of the method for the occupants.

FIG. 4 shows a flow diagram 400 of a method according to the invention. The method starts in a method step 401.

In a method step 402, a camera feed is tapped by at least one vehicle camera 3. In addition, sensor data generated by at least one sensor 9 can also be tapped. Driving dynamics of a corresponding vehicle 1.1, 1.2, 1.3 can also already be determined from the sensor data. For this purpose, at least one sensor 9 is able to measure a vehicle speed, vehicle acceleration and/or a steering angle.

In the method step 403, a user, that is to say a person driving the vehicle, is identified and a user profile assigned to the respective person is loaded.

In the method step 404, it is checked whether a machine learning model has been sufficiently trained to determine the future driving dynamic information corresponding to a user-specific profile in order to derive the future driving dynamic information from the driving behavior of the user. If this is not the case, then, in the method step 405, the current driving dynamics and external camera recordings are recorded and compared with later driving dynamic data. In other words, the machine learning model is trained with the aid of the recorded current and later driving dynamic data in order to estimate future driving dynamic data from driving dynamic data and external camera recordings.

The machine learning model is trained further in the method step 406.

If, on the other hand, the corresponding machine learning model is sufficiently trained, then, in the method step 407, the future driving dynamic information is estimated by the computing unit 7 from at least one camera image extracted from the camera feed and/or the sensor data.

In the method step 408, the current and future driving dynamic information is transmitted to the central computing unit 4 together with the camera images.

In the method step 409, the central computing unit 4 compares the driving dynamic information transmitted to it from different vehicles 1.1, 1.2, 1.3.

Both the current and the future driving dynamic information is used here.

In the method step 410, it is checked whether there are at least two vehicles 1.1, 1.3 with matching driving dynamics. If this is the case, in the method step 411, the media content 2 recorded by the respective vehicles 1.1, 1.3 is exchanged. Finally, in the method step 412, the respective media content 2 is then output on the display devices 6 of the respective vehicle 1.1, 1.3. The method finally ends in the method step 413.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-12. (canceled)

13. A method for providing media content adapted to movement of a vehicle, the method comprising:
detecting current driving dynamic information of a first vehicle;
estimating future driving dynamic information of at least the first vehicle;
transmitting the current and future driving dynamic information and camera images recorded by a vehicle camera to a central computing unit;
providing the current or future driving dynamic information and the camera images from the central computing unit for outputting purposes by a third-party device or identifying current or future driving dynamic information of a second vehicle corresponding to at least the current or the future driving dynamic information of the first vehicle within a tolerance limit by the central computing unit;
transmitting the current or future driving dynamic information and the camera images of the second vehicle to the first vehicle; and
outputting at least the camera images of the second vehicle on at least one display device of the first vehicle.

14. The method of claim 13, wherein, in addition to the camera images and the current or future driving dynamic information, additional information is transmitted to at least one third-party device or the second vehicle for outputting purposes.

15. The method of claim 14, wherein at least one of the following variables is used as the additional information:
status information describing a status of the first vehicle;
surroundings information describing a status of surroundings of the first vehicle; or
an audio track in a form of external microphone recordings.

16. The method of claim 13, wherein a current or future road layout of a road being travelled along by the first vehicle, a current or future traffic situation, or a travel trajectory plan is taken into consideration to determine the future driving dynamic information.

17. The method of claim 16, wherein the current or future road layout or the current or future traffic situation is by:
image analysis of at least one camera image generated by the vehicle camera;
extraction of a variable derived from an assistance system; or
analysis of digital maps during active navigation.

18. The method of claim 13, wherein a person driving the first vehicle is identified and a clear profile is assigned to the person driving the first vehicle.

19. The method of claim 13, wherein machine learning methods are used for estimating the future driving dynamic information.

20. The method of claim 13, wherein the central computing unit compares with one another the roads travelled along by different vehicles and assigns to one another roads with a similar road layout above a minimum road length within a defined tolerance threshold.

21. The method of claim 13, wherein user preferences are taken into consideration for selecting or displaying media content.

22. The method of claim 13, wherein at least information on manual control of the first vehicle by a person driving the vehicle or at least a control command for at least partially automated control of the first vehicle is derived from the driving dynamic information transmitted from the second vehicle to the first vehicle.
